(19) United States
(12) Patent Application Publication
(10) Pub. No.: US 2026/0190179 A1
(43) Pub. Date: Jul. 2, 2026

(54) UE Measurement in Collided RAN and CN PTW

(71) Applicant: Apple Inc., CUPERTINO, CA (US)

(72) Inventors: Jie CUI, San Jose, CA (US); Dawei ZHANG, Saratoga, CA (US); Hong HE, San Jose, CA (US); Qiming LI, Beijing (CN); Xiang CHEN, Campbell, CA (US); Yang TANG, San Jose, CA (US)

(21) Appl. No.: 18/729,978

(22) PCT Filed: Jul. 21, 2023
(86) PCT No.: PCT/CN2023/108621

§ 371 Date: Jul. 18, 2024

(51) Int. Cl. H04W 76/28; H04W 76/27

(52) U.S. Cl. CPC H04W 76/28; H04W 76/27

(57) ABSTRACT

A user equipment (UE) is configured to decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determine a measurement scheme based on at least the PTW information and eDRX information and perform measurements of one or more wireless signals based on the measurement scheme, wherein when the RAN PTW duration is shorter than the CN PTW duration, the measurements of the one or more wireless signals are performed during the CN PTW duration.

### TECHNICAL FIELD

The present disclosure generally relates to wireless communication, and in particular, to UE measurement in collided RAN and CN PTW.

### BACKGROUND

A user equipment (UE) may operate in an extended discontinuous reception (eDRX) mode. The eDRX mode may encompass various connection modes, e.g., radio resource control (RRC) connected, RRC inactive, and RRC idle. Each eDRX connection mode features different associated costs and benefits with respect to power optimization, mobility optimization, and latency (among other factors).

A paging timing window (PTW) is a periodic interval during which a UE may attempt to receive paging. However, it is possible that a radio access network (RAN) PTW is different (e.g., length, periodicity, etc.) than a core network PTW. An unsolved issue in the field of network communications relates to how a UE should perform measurements in eDRX RRC inactive and RRC idle when the RAN PTW and core network PTW differ.

### SUMMARY

Some exemplary embodiments are related to an apparatus of a user equipment (UE) having processing circuitry configured to decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determine a measurement scheme based on at least the PTW information and eDRX information and perform measurements of one or more wireless signals based on the measurement scheme, wherein when the RAN PTW duration is shorter than the CN PTW duration, the measurements of the one or more wireless signals are performed during the CN PTW duration.

Other exemplary embodiments are related to an apparatus of a user equipment (UE) having processing circuitry configured to decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determine a measurement scheme based on at least the PTW information and eDRX information and perform measurements of one or more wireless signals based on the measurement scheme, wherein when the RAN PTW duration is shorter than the CN PTW duration, the measurements of the one or more wireless signals are performed during the RAN PTW duration.

Still further exemplary embodiments are related to an apparatus of a user equipment (UE) having processing circuitry configured to decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determine a measurement scheme based on at least the PTW information and eDRX information and perform measurements of one or more wireless signals based on the measurement scheme, wherein when the RAN PTW duration is longer than the CN PTW duration, the measurements of the one or more wireless signals are performed during the RAN PTW duration.

Additional exemplary embodiments are related to an apparatus of a user equipment (UE) having processing circuitry configured to decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determine a measurement scheme based on at least the PTW information and eDRX information and perform measurements of one or more wireless signals based on the measurement scheme, wherein when the RAN PTW duration is longer than the CN PTW duration, the measurements of the one or more wireless signals are performed during the CN PTW duration.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station, according to various exemplary embodiments.

FIG. 4A shows a first periodicity diagram illustrating an idle eDRX mode having a core network PTW and an inactive eDRX mode having a RAN PTW according to various exemplary embodiments.

FIG. 4B shows a second periodicity diagram illustrating the core network PTW and the RAN PTW of FIG. 4A according to various exemplary embodiments.

FIG. 5A shows a third periodicity diagram illustrating an idle eDRX mode having a core network PTW and an inactive eDRX mode having a RAN PTW according to various exemplary embodiments.

FIG. 5B shows a fourth periodicity diagram illustrating the core network PTW and the RAN PTW of FIG. 5A according to various exemplary embodiments.

FIG. 6A shows a fifth periodicity diagram illustrating an idle eDRX mode having a core network PTW and an inactive eDRX mode having a RAN PTW according to various exemplary embodiments.

FIG. 6B shows a sixth periodicity diagram illustrating the core network PTW and the RAN PTW of FIG. 6A according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) performing measurements when a radio access network (RAN) paging timing window (PTW) is collides with a core network PTW.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol (e.g., 6G networks), or any other type of network.

As described above, a UE may have a RAN PTW and a CN PTW. Determining when and how to perform network measurements at a UE considering different DRX cycles (associated with the aforementioned eDRX modes) and PTWs remains an open question in the field. Operations and logic are disclosed herein for UE measurement of reference signals (RSs) transmitted by the network when there are collided RAN and CN PTWs. The operations and logic may depend on various factors to determine the behavior of the UE including, but not limited to, the length of the respective PTW, the length of the respective eDRX cycle, the periodicity of the eDRX cycle, etc. The operations and logic are described in greater detail below.

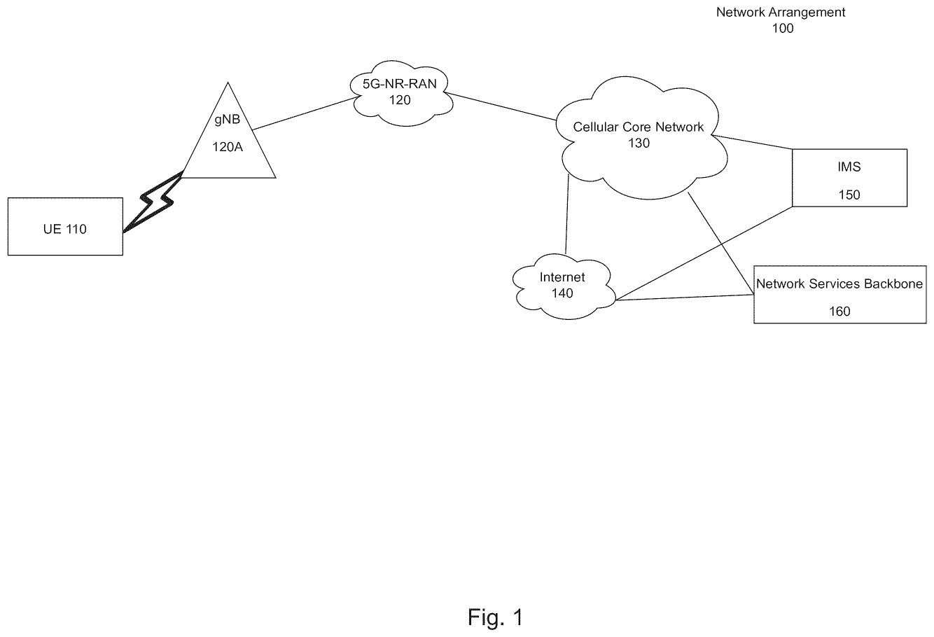

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices (including connected vehicles), etc. It should also be understood that an actual network arrangement may include any number of UEs being used by any number of users. Thus, the example of one UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.). Similarly, the term 5G is merely provided for illustrative purposes, any advanced cellular communications system may be deployed (e.g., 5G, 5G advanced, 6G, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

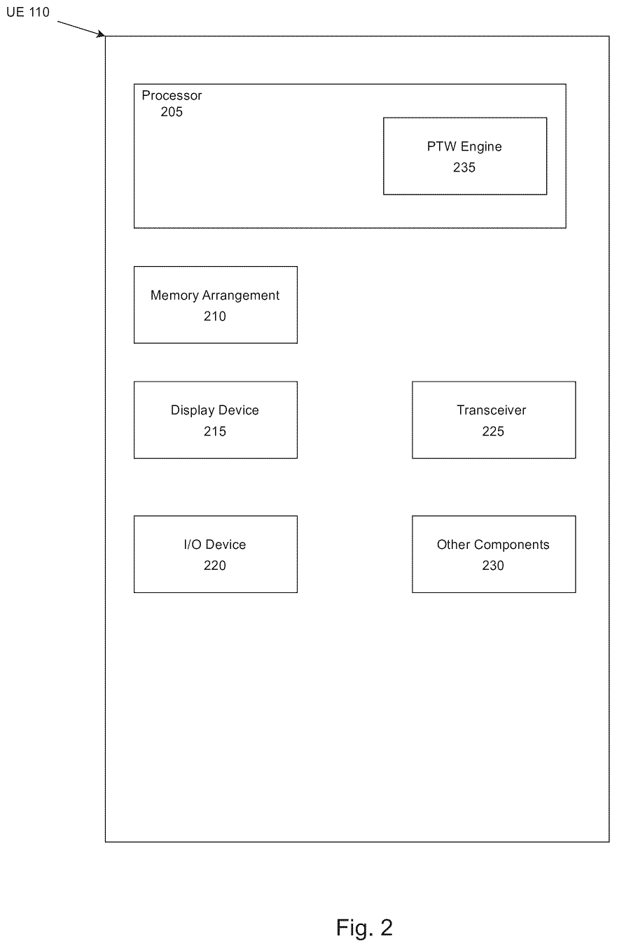

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a PTW engine 235 for performing operations related to the determination of when and how to perform signal measurements with various combinations of RAN PTWs and eDRX cycles.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

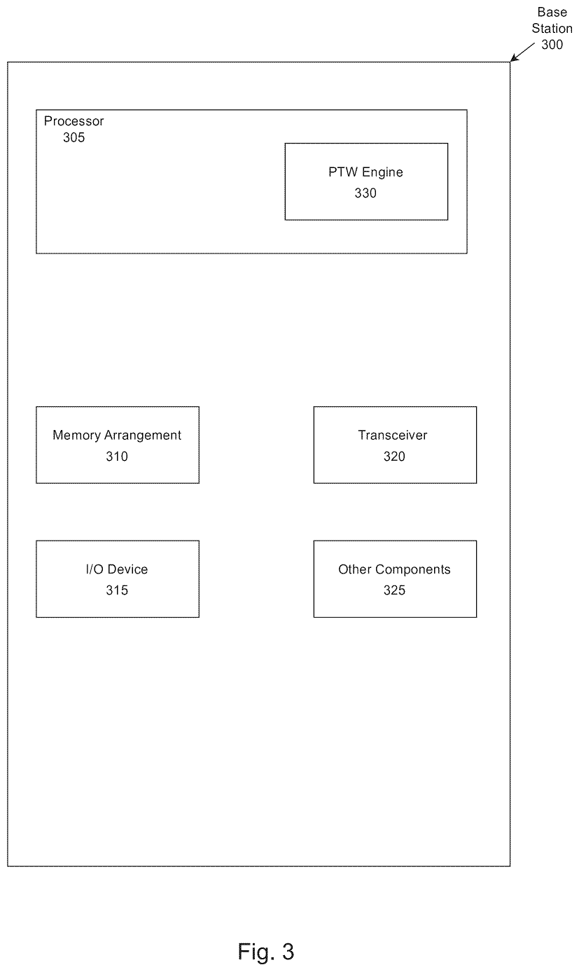

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a

memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a PTW engine 330 for transmitting to the UE 110 measurement configurations for various configurations of PTWs and eDRX cycles.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

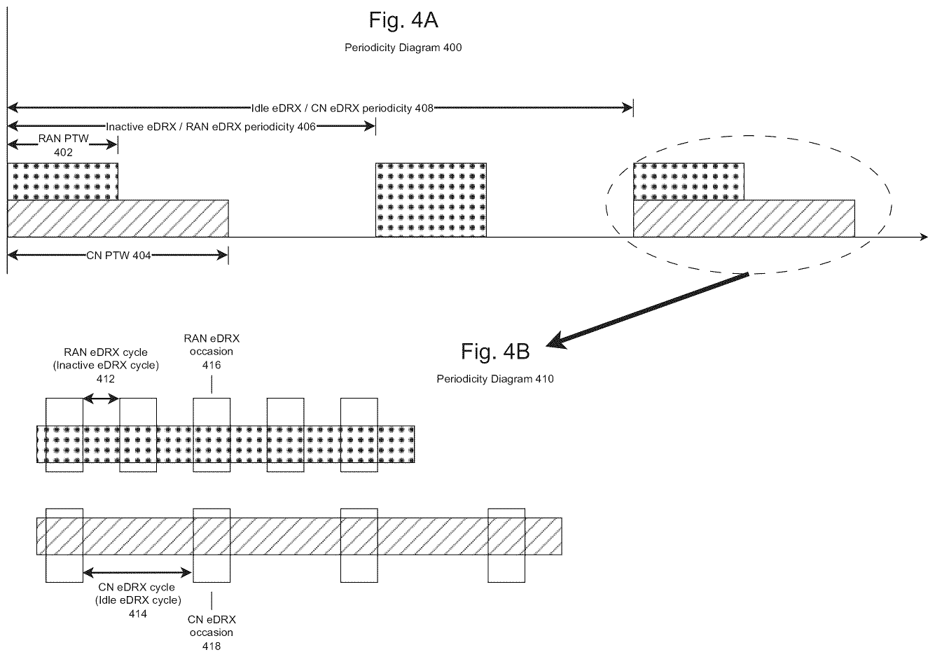

FIG. 4A shows a first periodicity diagram 400 illustrating an idle eDRX mode having a core network PTW and an inactive eDRX mode having a RAN PTW according to various exemplary embodiments. FIG. 4B shows a second periodicity diagram 410 illustrating the core network PTW and the RAN PTW of FIG. 4A according to various exemplary embodiments. Together, FIGS. 4A and 4B will be described to introduce fundamental concepts related to the exemplary embodiments.

The periodicity diagram 400 will be described first. It should be noted that moving left to right along both FIG. 4A and FIG. 4B correspond with moving forward in the time domain.

FIG. 4A shows a RAN (i.e., inactive mode) eDRX periodicity 406. In addition, FIG. 4A also shows a RAN PTW 402 occurring within the RAN eDRX periodicity 406. It should be understood that each RAN eDRX periodicity 406 includes a RAN PTW 402. FIG. 4A also shows a core network (CN) (i.e., idle mode) eDRX periodicity 408. A CN PTW 404 occurs within the CN eDRX periodicity 404. It should be understood that each CN eDRX periodicity 408 includes a CN PTW 404.

Turning now to FIG. 4B and the periodicity diagram 410, it should be understood that the periodicity diagram 410 shows one instance of a RAN PTW 402 overlapped with a CN PTW 404 of FIG. 4A. FIG. 4B also shows a RAN eDRX cycle 412 and a CN eDRX cycle 414, respectively, where the bars represent instances where the UE 110 will be listening for transmissions from the network during the respective eDRX cycle, e.g., eDRX occasions as described in greater detail below. As shown in the periodicity diagram 410, the periodicity of the RAN eDRX cycle 412 may be “T” and the periodicity of the CN eDRX cycle may be “3T”, though this is only exemplary and other ratios are possible and within the scope of the exemplary embodiments. For example, for every three RAN DRX cycles 412, there is only a single CN eDRX cycle 414.

The RAN eDRX cycle 412 corresponds to a plurality of RAN eDRX occasions, such as a RAN eDRX occasion 416. It should be noted that the other unlabeled RAN eDRX occasions are identical in functionality and periodicity as the labeled RAN eDRX occasion 416.

The CN eDRX cycle 414 corresponds to a plurality of CN eDRX occasions, such as a CN eDRX occasion 418. It should be noted that the other unlabeled CN eDRX occasions are identical in functionality and periodicity as the labeled CN eDRX occasion 418.

Various parameter combinations of PTW window lengths and eDRX cycle periodicities must be accounted for to ensure proper UE signal measurement.

In a first aspect of the exemplary embodiments, UE measurement logic and procedures are disclosed for a situation in which the RAN PTW length is smaller than the CN PTW length. More specifically, the first aspect will be broken down into two scenarios: when the RAN RDX occasion is overlapped with the CN DRX occasion and, when the RAN DRX occasion is not overlapped with the CN DRX occasion. Each scenario has various associated options and these options will be appropriately noted as they are described.

In the first scenario of the first aspect, a RAN eDRX occasion overlaps with a CN eDRX occasion. Returning to FIG. 4B, this may be seen with the RAN eDRX occasion 416 overlapping the CN eDRX occasion 418 (i.e., the occasions 416 and 418 overlap in time on the x-axis). In the first scenario, the UE 110 should initially perform measurements based on the maximum of (RAN PTW, CN PTW). In the first scenario, this will be the CN PTW. For example, the CN PTW 404 is longer than the RAN PTW 402, and thus the UE 110 would perform measurements during the CN PTW window 404 (i.e., because it is larger than the RAN PTW 402).

In a first option of the first scenario, the UE 110 performs measurements based on always using the minimum of (RAN DRX cycle, CN DRX cycle) or the maximum of (RAN eDRX cycle, CN eDRX cycle).

For example, if the UE 110 is using the minimum of (RAN eDRX cycle, CN eDRX cycle), then based on the exemplary configuration shown in FIG. 4A and FIG. 4B, the UE 110 would perform measurements based on the RAN eDRX cycle 412 because it is smaller than the CN eDRX cycle 414. In summary, this option means that the UE 110 is measuring during the CN PTW 404 at the periodicity of the RAN eDRX cycle 412. This represents a more frequent measurement interval than if the option discussed above of maximum of (RAN eDRX cycle, CN eDRX cycle). One of skill in the art will appreciate that these different measurement intervals may be left to operator implementation and each offer advantages and disadvantages with respect to measurement quality and UE 110 power consumption.

In a second option of the first scenario, the UE 110 performs measurements based on the CN eDRX cycle when the CN eDRX cycle is in a CN PTW. For example, in FIG. 4B, the UE 110 would use the CN eDRX cycle 414 as the measurement periodicity during the time period of the CN PTW 404.

The third option of the first scenario may be applicable to scenarios in which the UE 110 is operating in inactive mode. So long as the UE 110 is operating in inactive mode, the UE 110 may perform measurements based on the RAN eDRX cycle 412, regardless of the PTW type (e.g., the CN PTW 404 or the RAN PTW 402).

In a fourth option of the first scenario, the UE 110 may perform measurements during the RAN PTW 402 using the RAN eDRX cycle 412 periodicity 412, and during the CN PTW 404 but outside the RAN PTW 402 using the CN eDRX cycle 414. For example, during the time covered by both the RAN PTW 402 and the CN PTW 404, the UE 110 may use the RAN eDRX cycle 412. During the time covered by only the CN PTW 404 and not the RAN PTW 402, the UE 110 would transition to using the CN eDRX cycle 414 (i.e., during the time =CN PTW 404 - RAN PTW 402).

In a fifth option of the first scenario, the UE 110 may perform measurements using a paging cycle “T” equal to the minimum (CN configured DRX cycle, RAN configured DRX cycle, default paging cycle broadcast in system information).

In another example, measurements in the first scenario may also be performed by the UE 110 during the minimum of (RAN PTW, CN PTW). In the exemplary FIG. 4A and FIG. 4B, the minimum would be the RAN PTW 402.

In a first option for when the UE 110 is using the minimum of (RAN PTW, CN PTW), the UE 110 performs measurements based on the RAN eDRX cycle when the RAN eDRX cycle is in a RAN PTW. For example, in FIG. 4B, the UE 110 would use the RAN eDRX cycle 412 as the measurement periodicity during the time period of the RAN PTW 402.

In a second option for when the UE 110 is using the minimum of (RAN PTW, CN PTW), the UE 110 may perform measurements using a paging cycle “T” equal to the minimum (CN configured DRX cycle, RAN configured DRX cycle, default paging cycle broadcast in system information).

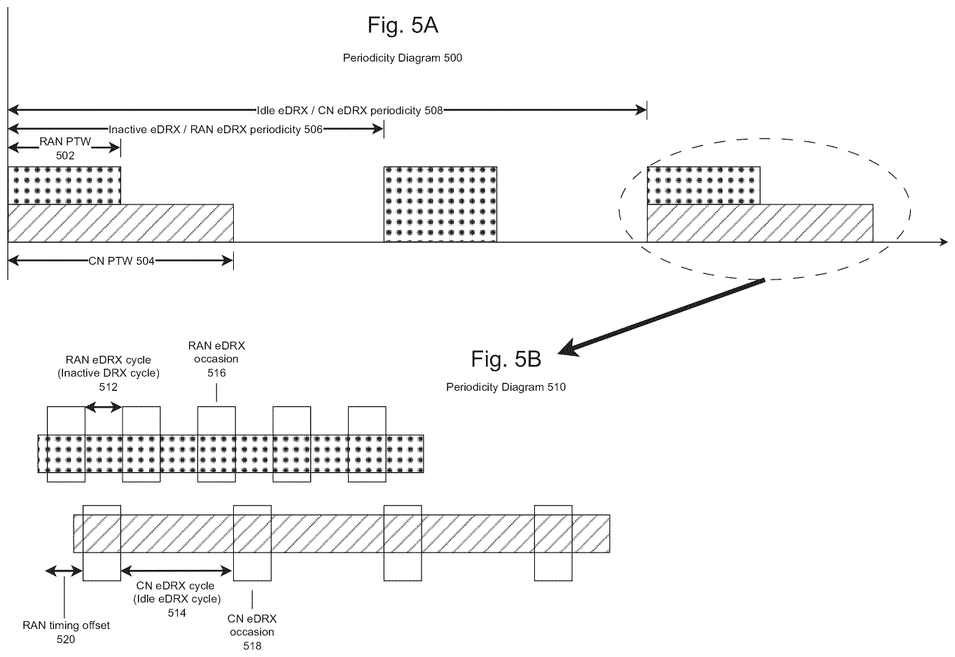

In the second scenario of the first aspect, a RAN eDRX occasion does not overlap with a CN eDRX occasion. Additionally, the RAN PTW length is smaller than the CN PTW length. FIG. 5A shows a third periodicity diagram 500 illustrating an idle eDRX mode having a core network PTW and an inactive eDRX mode having a RAN PTW according to various exemplary embodiments. FIG. 5B shows a fourth periodicity diagram 510 illustrating the core network PTW and the RAN PTW of FIG. 5A according to various exemplary embodiments.

FIG. 5A and FIG. 5B are similar to FIG. 4A and Fig. 4B, respectively, except that the CN eDRX occasion 518 does not overlap with the RAN eDRX occasion 516 (i.e., the occasions 516 and 518 do not overlap in time on the x-axis). This contrasts with what is shown in FIG. 4B, in which the CN eDRX occasion 418 does align with the RAN eDRX occasion 416. This non-alignment may be quantified by a value such as a RAN timing offset 520, which is depicted in FIG. 5B as the time between a RAN eDRX occasion 516 and a CN eDRX occasion 518.

In the second scenario, the UE 110 should initially perform measurements based on the maximum of (RAN PTW, CN PTW). In the second scenario, this will be the CN PTW. For example, the CN PTW 504 is longer than the RAN PTW 502, and thus the UE 110 would perform measurements during the CN PTW window 504 (i.e., because it is larger than the RAN PTW 502).

In a first option of the second scenario, the UE 110 may perform measurements based on always using the minimum (or optionally, the maximum) of (RAN DRX cycle, CN DRX cycle) with a timing offset of the DRX duration following the RAN DRX cycle configuration. For example, if using the maximum of RAN eDRX cycle 512 and the CN eDRX cycle 514, the UE 110 may use the larger CN eDRX cycle 514 periodicity for measurements. An offset for measurements is necessary because the RAN eDRX occasion 516 and the CN eDRX occasion 518 do not align. Accordingly, the UE 110 will use a timing offset based on the RAN eDRX cycle 512 (e.g., the RAN timing offset 520) to perform measurements.

In a second option of the second scenario, the UE 110 performs measurements based on the CN eDRX cycle when the CN eDRX cycle is in a CN PTW. For example, in FIG. 5B, the UE 110 would use the CN eDRX cycle 514 as the measurement periodicity during the time period of the CN PTW 504.

The third option of the first scenario may be applicable to scenarios in which the UE 110 is operating in inactive mode. So long as the UE 110 is operating in inactive mode, the UE 110 may perform measurements based on the RAN eDRX cycle 512, regardless of the PTW type (e.g., the CN PTW 504 or the RAN PTW 502).

In a fourth option of the second scenario, the UE 110 may perform measurements during the RAN PTW 502 using the RAN eDRX cycle 512 periodicity, and during the CN PTW 504 but outside the RAN PTW 502 using the CN eDRX cycle 514. For example, during the time covered by both the RAN PTW 502 and the CN PTW 504, the UE 110 may use the RAN eDRX cycle 512. During the time covered by only the CN PTW 404 and not the RAN PTW 502, the UE 110 would transition to using the CN eDRX cycle 514 (i.e., during the time =CN PTW 504 - RAN PTW 502).

In a fifth option of the second scenario, the UE 110 may perform measurements using a paging cycle “T” equal to the minimum (CN configured DRX cycle, RAN configured DRX cycle, default paging cycle broadcast in system information).

In a second aspect of the exemplary embodiments, UE measurement logic and procedures are disclosed herein for a situation in which the RAN PTW length is greater than the CN PTW length. More specifically, the second aspect will be further described with two scenarios based on the UE measuring during either the maximum or the minimum of (RAN PTW, CN PTW).

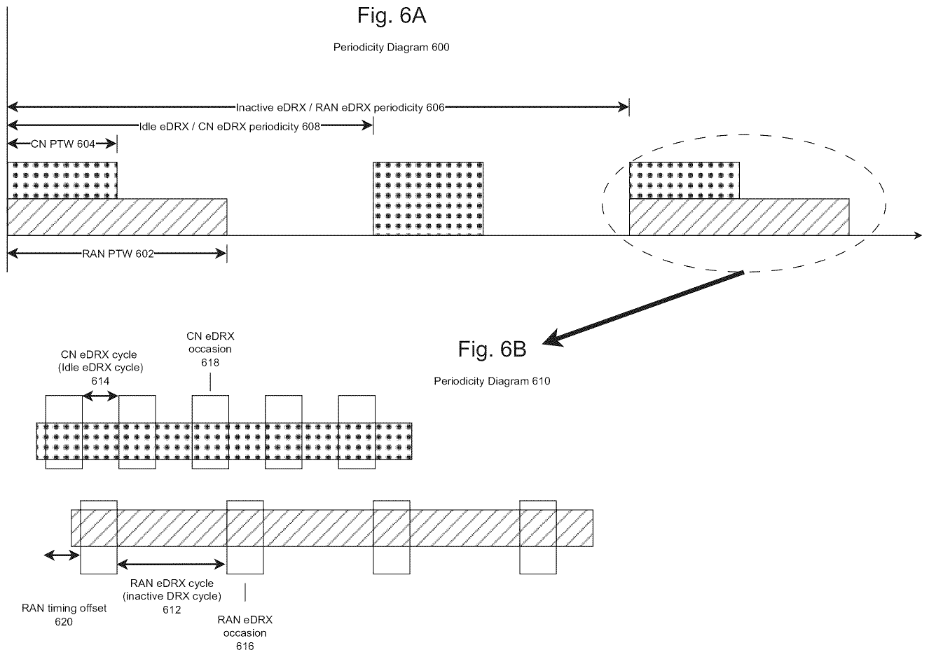

FIG. 6A shows a fifth periodicity diagram 600 illustrating an idle eDRX mode having a core network PTW and an inactive eDRX mode having a RAN PTW according to various exemplary embodiments. FIG. 6B shows a sixth periodicity diagram 610 illustrating the core network PTW and the RAN PTW of FIG. 6A according to various exemplary embodiments. FIG. 6A and FIG. 6B are similar to FIGS. 4A and 4B, respectively, except that the RAN PTW 602 is now longer than the CN PTW 604, the inactive eDRX/RAN eDRX periodicity 606 is now longer than the idle eDRX/CN eDRX periodicity 608, and the CN eDRX cycle 614 is now shorter than the RAN eDRX cycle 612. One of skill of the art will recognize that the CN eDRX cycle 614 and the RAN eDRX cycle 612 need not have changed in length to accommodate the RAN PTW 602 being longer than the CN PTW 604. In other words, the eDRX cycles 614 and 612 are independent of the lengths of the PTWs 604 and 602. Additionally, FIG. 6B shows the RAN eDRX occasion not being aligned with the CN eDRX occasion 618. This timing difference may be described with the RAN timing offset 620.

In the first scenario, the UE 110 performs measurements during the maximum of (RAN PTW, CN PTW). In the second aspect of the exemplary embodiments (as shown in FIGS. 6A and 6B), this would be the RAN PTW 602.

The first option of the first scenario may be applicable to scenarios in which the UE 110 is operating in inactive mode. So long as the UE 110 is operating in inactive mode, the UE 110 may perform measurements based on the RAN eDRX cycle 612, regardless of the PTW type (e.g., the CN PTW 604 or the RAN PTW 602).

In a second option of the first scenario, the UE 110 may perform measurements using a paging cycle “T” equal to the minimum (CN configured DRX cycle, RAN configured DRX cycle, default paging cycle broadcast in system information).

In a third option of the second scenario, the UE 110 may perform measurements based on always using the minimum (or optionally, the maximum) of (RAN DRX cycle, CN DRX cycle) with a timing offset of the DRX duration following the RAN DRX cycle configuration. For example, if using the maximum of RAN eDRX cycle 612 and the CN eDRX cycle 614, the UE 110 may use the larger RAN eDRX cycle 612 periodicity for measurements. An offset for measurements is necessary because the RAN eDRX occasion 616 and the CN eDRX occasion 618 do not align. Accordingly, the UE 110 will use a timing offset based on the RAN eDRX cycle 612 (e.g., the RAN timing offset 620) to perform measurements.

In a fourth option of the second scenario, the UE 110 may perform measurements during the CN PTW 604 using the CN eDRX cycle 614 periodicity, and during the RAN PTW 602 but outside the CN PTW 604 using the RAN eDRX cycle 612.

In the second scenario, the UE 110 performs measurements during the minimum of (RAN PTW, CN PTW). In the second aspect of the exemplary embodiments (as shown in FIGS. 6A and 6B), this would be the CN PTW 604.

The first option of the first scenario may be applicable to scenarios in which the UE 110 is operating in inactive mode. So long as the UE 110 is operating in inactive mode, the UE 110 may perform measurements based on the RAN eDRX cycle 612, regardless of the PTW type (e.g., the CN PTW 604 or the RAN PTW 602).

In the second option of the first scenario, may be applicable to scenarios in the UE 110 may perform measurements based on the CN PTW 604, so long as the UE 110 is operating during the CN PTW 604.

In a third option of the second scenario, the UE 110 may perform measurements using a paging cycle “T” equal to the minimum (CN configured DRX cycle, RAN configured DRX cycle, default paging cycle broadcast in system information).

### EXAMPLES

In a first example, a method is performed by a user equipment (UE), the method comprising decoding, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determining a measurement scheme based on at least the PTW information and eDRX information and performing measurements of one or more wireless signals based on the measurement scheme, wherein when the RAN PTW duration is shorter than the CN PTW duration, the measurements of the one or more wireless signals are performed during the CN PTW duration.

In a second example, the method of the first example, wherein at least one of the one or more RAN eDRX occasions are overlapped in a time domain with at least one of the one or more CN eDRX occasions.

In a third example, the method of the second example, wherein the measurement scheme is based on a minimum duration of the RAN eDRX cycle or the CN eDRX cycle.

In a fourth example, the method of the second example, wherein the measurement scheme is based on a maximum duration of the RAN eDRX cycle or the CN eDRX cycle.

In a fifth example, the method of the second example, wherein the measurement scheme is based on the CN eDRX cycle when the UE is operating in the CN PTW window.

In a sixth example, the method of the second example, wherein the measurement scheme is based on the RAN eDRX cycle when the UE is operating in a radio resource control (RRC) inactive mode.

In a seventh example, the method of the second example, wherein the measurement scheme is based on the RAN eDRX cycle when the UE is operating in the RAN PTW, and the CN eDRX cycle when the UE is operating in the CN PTW and outside the RAN PTW.

In an eighth example, the method of the second example, wherein the measurement scheme is based on a paging cycle of a minimum duration of a CN configured eDRX cycle, a RAN configured eDRX cycle, or a default paging cycle broadcast in a system information.

In a ninth example, the method of the first example, wherein none of the one or more RAN eDRX occasions are overlapped in a time domain with the one or more CN eDRX occasions, and wherein the RAN eDRX cycle further comprises a RAN eDRX offset.

In a tenth example, the method of the ninth example, wherein the measurement scheme is based on a minimum duration of the RAN eDRX cycle or the CN eDRX cycle and the RAN eDRX offset.

In an eleventh example, the method of the ninth example, wherein the measurement scheme is based on a maximum duration of the RAN eDRX cycle or the CN eDRX cycle and the RAN eDRX offset.

In a twelfth example, the method of the ninth example, wherein the measurement scheme is based on the CN eDRX cycle when the UE is operating in the CN PTW window.

In a thirteenth example, the method of the ninth example, wherein the measurement scheme is based on the RAN eDRX cycle when the UE is operating in a radio resource control (RRC) inactive mode.

In a fourteenth example, the method of the ninth example, wherein the measurement scheme is based on the RAN eDRX cycle when the UE is operating in the RAN PTW, and the CN eDRX cycle when the UE is operating in the CN PTW and outside the RAN PTW.

In a fifteenth example, the method of the ninth example, wherein the measurement scheme is based on a paging cycle of a minimum duration of a CN configured eDRX cycle, a RAN configured eDRX cycle, or a default paging cycle broadcast in a system information.

In a sixteenth example, a processor configured to perform any of the methods of the first through fifteenth examples.

In a seventeenth example, a method is performed by a user equipment (UE), the method comprising decoding, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determining a measurement scheme based on at least the PTW information and eDRX information and performing measurements of one or more wireless signals based on the measurement scheme, wherein when the RAN PTW duration is shorter than the CN PTW duration, the measurements of the one or more wireless signals are performed during the RAN PTW duration.

In an eighteenth example, the method of the seventeenth example, wherein the measurement scheme is based on the RAN eDRX cycle when the UE is operating in a radio resource control (RRC) inactive mode and in the RAN PTW.

In an nineteenth example, the method of the seventeenth example, wherein the measurement scheme is based on a paging cycle of a minimum duration of the CN configured eDRX cycle, the RAN configured eDRX cycle, or a default paging cycle broadcast in a system information.

In a twentieth example, a processor configured to perform any of the methods of the seventeenth through nineteenth examples.

In a twenty first example, a method performed by a user equipment (UE), the method comprising decoding, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determining a measurement scheme based on at least the PTW information and eDRX information and performing measurements of one or more wireless signals based on the measurement scheme, wherein when the RAN PTW duration is longer than the CN PTW duration, the measurements of the one or more wireless signals are performed during the RAN PTW duration.

In a twenty second example, the method of the twenty first example, wherein the measurement scheme is based on the RAN eDRX cycle when the UE is operating in a radio resource control (RRC) inactive mode.

In a twenty third example, the method of the twenty first example, wherein the measurement scheme is based on a minimum duration of the CN configured eDRX cycle, the RAN configured eDRX cycle, or a default paging cycle broadcast in a system information.

In a twenty fourth example, the method of the twenty first example, wherein the RAN eDRX cycle further comprises a RAN eDRX offset and wherein the measurement scheme is based on a minimum duration of the RAN eDRX cycle or the CN eDRX cycle and the RAN eDRX offset.

In a twenty fifth example, the method of the twenty first example, wherein the RAN eDRX cycle further comprises a RAN eDRX offset and wherein the measurement scheme is based on a maximum duration of the RAN eDRX cycle or the CN eDRX cycle and the RAN eDRX offset.

In a twenty sixth example, the method of the twenty first example, wherein the measurement scheme is based on the CN eDRX cycle when the UE is operating in the CN PTW, and the RAN eDRX cycle when the UE is operating in the RAN PTW and outside the CN PTW.

In a twenty seventh example, a processor configured to perform any of the methods of the twenty first through twenty seventh examples.

In a twenty eighth example, a method is performed by a user equipment (UE), the method comprising decoding, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions, determining a measurement scheme based on at least the PTW information and eDRX information and performing measurements of one or more wireless signals based on the measurement scheme, wherein when the RAN PTW duration is longer than the CN PTW duration, the measurements of the one or more wireless signals are performed during the CN PTW duration.

In a twenty ninth example, the method of the twenty eighth example, wherein the measurement scheme is based on the RAN eDRX cycle when the UE is operating in a radio resource control (RRC) inactive mode.

In a thirtieth example, the method of the twenty eighth example, wherein the measurement scheme is based on the CN eDRX cycle when the UE is operating in the CN PTW.

In a thirty first example, the method of the twenty eighth example, wherein the measurement scheme is based on a minimum duration of the CN configured eDRX cycle, the RAN configured eDRX cycle, or a default paging cycle broadcast in a system information.

In a thirty second example, a processor configured to perform any of the methods of the twenty eighth through thirty first examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions;
determine a measurement scheme based on at least the PTW information and eDRX information; and
perform measurements of one or more wireless signals based on the measurement scheme, wherein when the RAN PTW duration is shorter than the CN PTW duration, the measurements of the one or more wireless signals are performed during the CN PTW duration.

2. The apparatus of claim 1, wherein at least one of the one or more RAN eDRX occasions are overlapped in a time domain with at least one of the one or more CN eDRX occasions.

3. The apparatus of claim 2, wherein the measurement scheme is based on a minimum duration of the RAN eDRX cycle or the CN eDRX cycle.

4. The apparatus of claim 2, wherein the measurement scheme is based on a maximum duration of the RAN eDRX cycle or the CN eDRX cycle.

5. The apparatus of claim 2, wherein the measurement scheme is based on the CN eDRX cycle when the UE is operating in the CN PTW window.

6. The apparatus of claim 2, wherein the measurement scheme is based on the RAN eDRX cycle when the UE is operating in a radio resource control (RRC) inactive mode.

7. The apparatus of claim 2, wherein the measurement scheme is based on the RAN eDRX cycle when the UE is operating in the RAN PTW, and the CN eDRX cycle when the UE is operating in the CN PTW and outside the RAN PTW.

8. The apparatus of claim 2, wherein the measurement scheme is based on a paging cycle of a minimum duration of a CN configured eDRX cycle, a RAN configured eDRX cycle, or a default paging cycle broadcast in a system information.

9. The apparatus of claim 1, wherein none of the one or more RAN eDRX occasions are overlapped in a time domain with the one or more CN eDRX occasions, and wherein the RAN eDRX cycle further comprises a RAN eDRX offset.

10. The apparatus of claim 9, wherein the measurement scheme is based on a minimum duration of the RAN eDRX cycle or the CN eDRX cycle and the RAN eDRX offset.

11. The apparatus of claim 9, wherein the measurement scheme is based on a maximum duration of the RAN eDRX cycle or the CN eDRX cycle and the RAN eDRX offset.

12. The apparatus of claim 9, wherein the measurement scheme is based on the CN eDRX cycle when the UE is operating in the CN PTW window.

13. The apparatus of claim 9, wherein the measurement scheme is based on the RAN eDRX cycle when the UE is operating in a radio resource control (RRC) inactive mode.

14. The apparatus of claim 9, wherein the measurement scheme is based on the RAN eDRX cycle when the UE is operating in the RAN PTW, and the CN eDRX cycle when the UE is operating in the CN PTW and outside the RAN PTW.

15. The apparatus of claim 9, wherein the measurement scheme is based on a paging cycle of a minimum duration of a CN configured eDRX cycle, a RAN configured eDRX cycle, or a default paging cycle broadcast in a system information.

16. An apparatus of a user equipment (UE), the apparatus comprising processing circuitry configured to:
decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions;
determine a measurement scheme based on at least the PTW information and eDRX information; and
perform measurements of one or more wireless signals based on the measurement scheme, wherein when the RAN PTW duration is shorter than the CN PTW duration, the measurements of the one or more wireless signals are performed during the RAN PTW duration.

17. The apparatus of claim 16, wherein the measurement scheme is based on the RAN eDRX cycle when the UE is operating in a radio resource control (RRC) inactive mode and in the RAN PTW.

18. The apparatus of claim 16, wherein the measurement scheme is based on a paging cycle of a minimum duration of the CN configured eDRX cycle, the RAN configured eDRX cycle, or a default paging cycle broadcast in a system information.

19. An apparatus of a user equipment (UE), the apparatus comprising processing circuitry configured to:
decode, from signals received from a base station, paging time window (PTW) information and extended discontinuous reception (eDRX) information, wherein the PTW information comprises a (i) radio access network (RAN) PTW duration and (ii) a core network (CN) PTW duration, and wherein the eDRX information comprises (i) a RAN eDRX cycle comprising one or more RAN eDRX occasions and (ii) a CN eDRX cycle comprising one or more CN eDRX occasions;
determine a measurement scheme based on at least the PTW information and eDRX information; and
perform measurements of one or more wireless signals based on the measurement scheme, wherein when the RAN PTW duration is longer than the CN PTW duration, the measurements of the one or more wireless signals are performed during the RAN PTW duration.

20. The apparatus of claim 19, wherein the measurement scheme is based on the RAN eDRX cycle when the UE is operating in a radio resource control (RRC) inactive mode.
